(19) United States
(12) Patent Application Publication
(10) Pub. No.: US 2014/0207626 A1
(43) Pub. Date: Jul. 24, 2014

(54) SYSTEM AND METHOD OF SELLING MARKET-BASED ACCESS TO SCARCE RESOURCES

(71) Applicant: Peter K. Braxton, Chicago, IL (US)

(72) Inventor: Peter K. Braxton, Chicago, IL (US)

(21) Appl. No.: 13/744,512

(22) Filed: Jan. 18, 2013

(51) Int. Cl. G06Q 30/06

(52) U.S. Cl. CPC G06Q 30/0601
USPC 705/27.1; 705/26.1

(57) ABSTRACT

A method of providing real-time market prices to purchase access to the desired places, products, events, services, etc. includes the step of providing a user interface through which a real-time, market-based, variable price for accessing a preferred position in an existing queue for a scarce resource is presented to a user, whereby the user may purchase access to the preferred position in the queue at the real-time, market-based variable price. The user interface may be provided through a mobile electronic device. In one example, a system for providing real-time, market-based access to a scarce resource includes: a mobile electronic device; and a user interface enabling a user to purchase access to a preferred position in an existing queue for a scarce resource at a real-time, market-based, variable price through the mobile electronic device.

### BACKGROUND OF THE INVENTION

The present subject matter relates generally to systems and methods for securely offering and selling market-based preferred and priority access to scarce resources such as places, products, events, services, etc. More specifically, the present subject matter provides systems and methods in which real-time market prices are provided to users of the system from the offer and purchase of access to the desired scarce resources to capturing economics associated with the exchange of products, access to events or services; etc. Any business that has a queue can benefit from a system and method that identifies customers that are willing to pay for priority.

There are numerous situations in which you might want to gain priority access to scarce resources. For example, you might want to skip waiting in line to gain access to a bar or nightclub. Similarly, rather than wait in the order one arrives for a table at a restaurant, you may wish to move to the top of the list. When the newest electronics, toys or sneakers are released and the products are backordered, you may want to be put in a preferred place on the waiting list. When making appointments with busy service providers, such as lawyers, you may wish to be able to reserve an appointment to urgently handle an important legal matter. It is easy to see that people may wish to gain priority or preferred access to scarce resources in wildly varying circumstances: event tickets and seats; hotel rooms; restricted use lanes on roads; dental appointments; etc.

In addition, real-time changes in conditions can have a dramatic effect on the value of priority and preferred access to scarce resources. For example, supply and demand factors including, inventory, capacity, frequency of purchase, day, time of day, holidays and the weather, among others, can have significant effects on the value of access to a given resource. It may be fine on a typical night to wait in line to get into a club, but when you are out with a group of friends celebrating a bachelor party or with an important person or client, it may be much more valuable to you to be able to skip the line. Similarly, it might not be an inconvenience to wait for a table at your favorite restaurant most nights, but when you and your date would like to get in and out in time to catch a movie, the ability to get seated faster may be valuable. The movie itself might be a new release or a popular sequel, and paying a premium for early access to the theater or reserved seating might be something you would purchase, if only you had the opportunity. Waiting your turn at a taxi stand may not be a problem most nights, but if it is raining, or you are racing to catch a flight or get to an important meeting, you may place a much higher value on jumping to the front of the line. Similarly, if you are in traffic, headed to that same meeting or flight, there is a higher value to getting past traffic and gaining access to a traffic lane that is reserved for people willing to pay. These situations, and many others, would be improved if there were opportunities to buy your way to the front of the line or get immediate access to a good, service, event, or product.

In many situations, there is a gatekeeper that acts to grant priority access to the scarce resources. For example, a bouncer at a club might grant priority access to people in line based on relationships (e.g., his friends), social status (e.g., celebrities), demographics (e.g., women get in before men), and/or payment (e.g., a $100 bill can shorten your wait). These types of gatekeepers exist regulating access to all kinds of places, products, events, services, etc. However, these gatekeepers are not always efficient. Using the club example, the club needs to have a bouncer and the bouncer must understand how to optimize the access. Even the best bouncer might have a difficult time identifying a high-quality club patron (e.g., a big spender) visiting from out of town. Yet, with better information, the club may specifically want this high-quality patron to be given priority access. Current systems and methods are not well adapted to optimize priority access in these situations.

There are existing systems and methods that provide preferred access based on static price models. Static price models for providing preferred and priority access to scarce resources are naturally inefficient and opaque. Static models are not adaptive to the real-time changes in value of the access to the resources. Without prices that closely match value, there is inefficient use of the resources. For example, enabling the use at real-time market-clearing prices may optimize the use of toll roads. Real-time, market clearing cover charges for club entry can optimize the door receipts at clubs and may further help club owners to effectively screen for more valuable customers (e.g., those willing to pay more to get in faster may also be willing to spend more once they are in the club). Further, people would pay to improve their position or access to said services or resources, if the terms, conditions, and price were electronically indicated or updated as conditions change.

Existing systems and methods are inefficient at identifying people that are willing to pay for preferred access to scarce resources. A benefit of identifying people that would be willing to pay, or pay a premium, for access would be to sell that access directly to them. Further, if people were to be identified as being willing to pay a premium, it would be beneficial to further upsell the customer on additional or preferred access to places, products, events, services, etc. With newfound visibility of premium paying customers—real time targeted marketing would take on a whole new definition. It also might mean a whole new revenue stream for a resource constrained, overwhelmed civic or government service, such as the DMV (Department of Motor Vehicles). Capturing economics from individuals willing to pay for preferred access, if done thoughtfully and efficiently, would be advantageous throughout the entire ecosystem based on unrealized and uncaptured revenue from consumer demand.

As can be understood from the explanation above, monetizing access to places, products, events, services, etc. can be beneficial to parties on each side of the transaction. Accordingly, there is a need for systems and methods to provide real-time market prices for the purchase of access to scarce resources or inventory that changes based on supply and demand.

### BRIEF SUMMARY OF THE INVENTION

The present disclosure provides systems and methods in which real-time market prices are provided to users of the system to purchase access to the desired places, products, events, services, etc.

In one example, a method of providing real-time market prices to purchase access to the desired places, products, events, services, etc. includes the step of providing a user interface through which a real-time, market-based, variable price for accessing a preferred position in an existing queue for a scarce resource is presented to a user, whereby the user may purchase access to the preferred position in the queue at the real-time, market-based variable price.

The user interface may typically be provided through a mobile electronic device, though there may be situations in which the user interface is provided through other electronic devices. In one example in which the user interface is provided through a mobile electronic device, a system for providing real-time, market-based access to a scarce resource includes: a mobile electronic device; and a user interface enabling a user to purchase access to a preferred position in an existing queue for a scarce resource at a real-time, market-based, variable price through the mobile electronic device.

In an illustrative example, the user interface is provided as a mobile application running on a user's smartphone. Real-time, market-based access to priority access to scarce resources may be provided to the user through the user's engagement with the user interface. The mobile application may further be adapted to provide push notifications to the user to proactively present purchasing opportunities to users, even when the user is not actively engaged with the mobile application.

As described further herein, by way of the systems and methods provided herein, a user may be given an opportunity to purchase access to a preferred position in an existing queue for a scarce resource at a real-time, market-based, variable price. For example, a user waiting in line at a nightclub may, through the user interface provided in his smartphone, purchase the ability to skip the line and enter the nightclub immediately (i.e., preferred or priority access to the scarce resource). The price to purchase the priority access may be determined from any one or more market-related factors. Such market-related factors may include supply and demand factors such as inventory, capacity, frequency of purchase, day, time of day, holidays, weather, etc. The market-related factors may further or alternatively include demographic related information and/or the past behavior of a specific user or type of user. For example, in some situations, it may be beneficial to lower the price charged for priority access to a specific user to encourage that user to engage with the seller. For example, the market-value price to encourage a user that is known to be a big spender at a specific venue may be lower than the price for other users because the venue would like to encourage the big spender to be able to gain priority access ahead of other customers.

As shown, the systems and methods provided herein a well adapted to address real-time market value for situations in which a queue exists. As used herein, a queue may be any form of line, whether tangible or intangible. For example, in the nightclub example above, the line is a physical line of people waiting to enter the venue. However, the teachings herein are equally applicable to lines that are less apparent. For example, a queue may be a wait list for a product, wait time for speaking with a customer service representative (in person, on the phone, online), priority to schedule an appointment with a doctor, etc.

In addition to the situations in which the systems and methods provided herein are adapted to address queue-related access, the systems and methods provided herein can be adapted to evaluate a user's activity combined with additional information to identify marketing and sales opportunities. For example, various demographic information and user activity data can be combined with additional conditions (e.g., market-based conditions, proximity conditions, environmental conditions, etc.) to identify and act on opportunities to directly market/sell to specific persons based, in part, on buying habits demographics, both personal buying habits and community buying habits. The additional opportunities may be particularly useful because they add efficiency to the marketing ecosystem, mitigate and eliminating marketing mistakes, and allow for more targeted marketing.

For example, the systems and methods may identify that a user is male, age 28 (e.g., demographic information), and has actively purchased priority access to a specific highway lane to avoid traffic (e.g., user activity), the traffic being heavier than usual because inclement weather or time of day has contributed to more traffic in the non-priority lanes (e.g., environmental conditions). That information is monitored and evaluated to provide an enhanced user experience not only for the specific user, but also for others or similar demographics who have made similar decisions. In the future, the systems and methods may know from proximity of a mobile device or other factors that this user, or someone like him, may be waiting in a queue at a taxi stand. The systems and methods may suggest to the user to purchase preferred access to a car service or change the price of access to the car service to reflect market based buying conditions. There are limitless combinations of the demographic information, user activity, and environmental conditions that may be used to identify opportunities to make offers to users, and, particularly when combined with the user's location, which may be derived from the location of an associated mobile electronic device, present new opportunities to identify users that may be willing to purchase priority access to a scarce resource.

While the example of purchasing priority access to a highway lane during times of inclement conditions may illustrate a very easy to understand relationship between the purchase and the conditions, there are numerous relationships that may not be as readily apparent. For example, the value of priority access to movie tickets may also vary in relation to the weather. Those skilled in the art will recognize a wide range of relationships that may be leveraged based on the disclosure provided herein.

Additional illustrative examples of how the systems and methods provided herein may be used are provided to help teach the value of the teachings herein. For example, when a baseball team makes it to the playoffs, a die-hard fan that normally watches games from TV at home might want to go to the game. Embodiments of the systems and methods provided herein may market/sell to the fan based on known demographic information (e.g., self-identified baseball fan), prior activity (e.g., previously purchased tickets to games of the playoff team), and the location of the user's mobile device to provide a proactive offer to the fan to purchase tickets.

Then, while at the game, the fan may wish to improve his seat. It is conceivable that there may be a queue of fans wanting to move closer to the field to unoccupied seats for a better view. Real-time, market based priority access to these tickets may be provided based on the disclosures provided herein. As a fan moves to a better position, the vacated seat may be offered to others. The real-time nature of the transactions may enable a more complete utilization of the resources (i.e., seats in the stadium).

In another example, a user of a mobile application on a mobile electronic device embodying the teachings provided herein may be stuck in line at the department of motor vehicles. The app may recognize that the user previously bought priority access to a steak house. The app could recognize the user's position (e.g., GPS position of the smartphone), the user's past purchasing habits (e.g., the previously purchased priority access), the user's demographic information (e.g., gender, age, self-identified preferences, etc.), and proactively offer the opportunity to purchase priority access to the front of the line.

As described above, one example of a method according to the disclosures provided herein may be a method of providing real-time market prices to purchase access to the desired places, products, events, services, etc. includes the step of providing a user interface through which a real-time, market-based, variable price for accessing a preferred position in an existing queue for a scarce resource is presented to a user, whereby the user may purchase access to the preferred position in the queue at the real-time, market-based variable price. Further, as noted above, in one example, a system for providing real-time, market-based access to a scarce resource includes: a mobile electronic device; and a user interface enabling a user to purchase access to a preferred position in an existing queue for a scarce resource at a real-time, market-based, variable price through the mobile electronic device.

In various embodiments of the systems and methods, the user may take a single action to purchase access to the preferred position in the queue at the real-time, market-based price. For example, a user may identify the priority access the user wishes to purchase, take action through the mobile electronic device to purchase the priority access, and then be provided an access code the user may show to the gatekeeper (e.g., doorman, hostess, access code entry field in an electronic form, etc.) to claim the preferred position.

As used herein, a preferred position, may refer to various forms of priority access. In one example, a preferred position enables the user to immediately bypass a queue. In another example, a preferred position may be a better position along a queue than the user would be positioned without the purchase.

In another example, a method according to the present disclosure may include the step of providing a user interface through a mobile electronic device through which a real-time, market-based, variable price for accessing a scarce resource is presented to a user in response to the location of the mobile electronic device and one or more characteristics of the user, whereby the user may purchase access to the scarce resource at the real-time, market-based variable price. The one or more characteristics of the user ay include demographic characteristics, prior user activity, user location, etc. For example, the one or more characteristics of the user may include purchase history characteristics, may include one or more characteristics of the user are derived from the user's interaction with the user interface, may include one or more characteristics are derived from one or more sources other than the user's interaction with the user interface (e.g., purchase history wherein the purchase did not occur through the user interface), etc.

An advantage of the systems and methods provided herein is that they enable offering and selling market-based preferred and priority access to scarce resources such as places, products, events, services, etc.

Another advantage of the systems and methods provided herein is that they create a forum for market based transactions related to access to scarce resources.

Another advantage of the systems and methods provided herein is that they enable vendors to capitalize on opportunities to more effectively sell to their preferred customers.

A further advantage of the systems and methods provided herein is that they enable real-time market valuation of access to scarce resources.

Yet another advantage of the systems and methods provided herein is that they enable the optimized selling of access to scarce resources at market-clearing prices.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram of an embodiment of a system for selling access to scarce resources.

FIG. 2 is a schematic diagram of an embodiment of a user interface through which a user buys access to scarce resources.

FIG. 3 is a flow chart depicting a method of selling access to scarce resources.

FIG. 4 is a flow chart depicting another method of selling access to scarce resources.

FIG. 5 is a flow chart depicting another method of selling access to scarce resources.

### DETAILED DESCRIPTION OF THE INVENTION

The systems and methods described above may be embodied in various forms. The detailed description with reference to the figures that follows is intended to further illustrate embodiments of the systems and methods. However, it is understood that the scope of the claimed subject matter will be understood by those skilled in the art based on the disclosures provided herein.

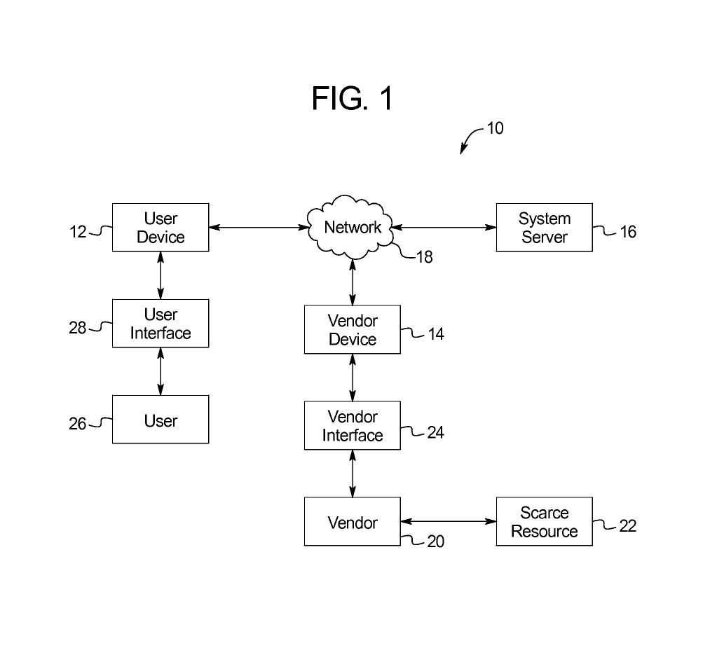

FIG. 1 illustrates an example of an embodiment of a system for providing real-time, market-based access to scarce resources 10 (system 10). As shown in FIG. 1, the system 10 includes: one or more user devices 12, one or more vendor devices 14, and a system server 16. As shown, the user devices 12 and vendor devices 14 communicate with the system server 16 through one or more communications networks 18. As described further herein, one or more vendors 20 may provide information regarding the one or more scarce resources 22 for which access is to be offered to the system server 16 through their respective vendor devices 14 using a vendor interface 24. The system server 16 may use the information communicated through the user devices 12 and the vendor devices 14 to provide data regarding real-time, market-based access to scarce resources to one or more users 26 through a user interface 28 provided through the user devices 12.

The user device 12 shown in FIG. 1 may be, for example, a mobile electronic device, such as, a smartphone, a tablet computer, etc. Generally speaking, a user device 12 is most typically a handheld device, commonly including a display screen with touch input, a keyboard, and/or additional input devices. The user device 12 includes an operating system and can run various types of application software. The user device 12 may be equipped with cellular communication capabilities, WI-FI, Bluetooth, GPS, and NFC capabilities that can allow the user device 12 to connect to the Internet, connect to other Bluetooth capable devices, identify the location of the user device 12, and otherwise communicate with other devices and systems, both near and far. While it is contemplated that the most commonly implemented user device 12 will be a mobile electronic device, particularly due to the likelihood that a user will have a mobile electronic device on hand at the moment priority access to a scarce resource 22 will be desired and further due to the important of location based services to various aspects of the system 10, it is understood that the user device 12 may be any electronic device through which the user interface 28 may be provided.

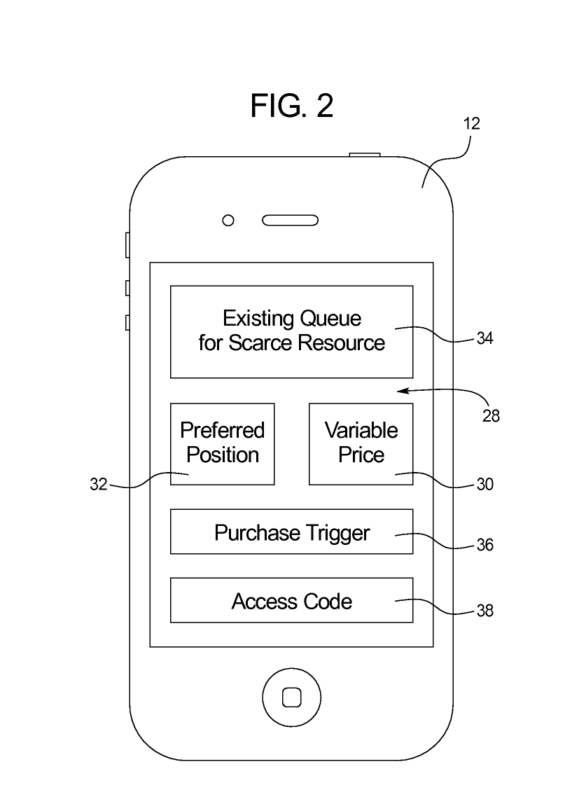

The user interface 28 shown in FIG. 1 is an application resident on a user device 12. For example, the user interface 28 may be a mobile application provided on a smartphone. The user interface 28 may provide various displays, inputs, and outputs and described below with reference to FIG. 2.

The vendor device 14 shown in FIG. 1 is a computing device through which a vendor 20 may access and interact with a vendor interface 24 to provide information about a scarce resource 22 for which priority access is to be offered. It is understood that the vendor device 14 may be any electronic computing device, whether mobile, handheld, etc.

The scarce resource 22 shown in FIG. 1 may be any scarce resource 22 for which a vendor 20 may wish to provide an opportunity for a user 26 to buy priority access to. As shown by the various examples provided herein, the scarce resource 22 may be any event, venue, product, service, etc. The scarce resource 22 may further be a specific position in a queue for access to an underlying resource 22 or other preferred position with respect to the scarce resource 22.

The system server 16 shown in FIG. 1 is a controller from which an application is run to provide the various functionality for the user device 12 and the vendor device 14. The system server 16 may be embodied in one or more system servers 16. The system server 16 may run a variety of application programs, may access and store data, including accessing and storing data in an associated database (which may be embodied in one or more databases) and may enable one or more interactions via various interfaces, including the user interface 28 and the vendor interface 24.

Typically, the system server 16 is implemented using one or more programmable data processing devices. The hardware elements operating systems and programming languages of such devices are conventional in nature, and it is presumed that those skilled in the art are adequately familiar therewith. Similarly, the systems and methods may be implemented on and integrated with dedicated applications, web servers, social networking platforms, etc.

For example, the system server 16 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories may include a main memory, such as a dynamic random access memory (DRAM) and cache, as well as a read only memory, such as a PROM, an EPROM, a FLASH-EPROM, or the like. The system server 16 may also include mass storage devices such as various solid-state drives, disk drives, tape drives, etc. In operation, the main memory may store at least portions of instructions for execution by the CPU and data for processing in accord with the executed instructions.

The system server 16 may also include one or more input/output interfaces for communications with one or more processing systems. One or more such interfaces may enable communications via the network 18 to enable sending and receiving instructions electronically.

Those skilled in the art will recognize that the description of the system server 16 also encompasses all kinds of controllers such as host computers, workstations, network terminals, and the like. In fact, the use of the term system server 16 is intended to represent a broad category of components that are well known in the art.

As described herein, aspects of the system 10 encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

Turning now to FIG. 2, the user interface 28 may be provided in a user device 12 embodied in a mobile electronic device, such as a smartphone. The user interface 28 may include various information and interactive functions through which a user 26 may view a real-time, market-based, variable price 30 for accessing a preferred position 32 in an existing queue 34 for a scarce resource 22 and, further, the user may purchase access to the preferred position in the queue at the real-time, market-based price using a purchase trigger 36. In response to the activation of the purchase trigger 36, the user interface 28 may provide an access code 38 to the user 26. While shown in FIG. 2 in a single display with each of the elements visible at once, it is contemplated that the display of the elements described may be provided over numerous displays and that not all of the elements may be visible to a user 26 at a single point in time.

As shown in FIG. 2, the user interface 28 may display data regarding an existing queue for a scarce resource 34. For example, the existing queue for scarce resource 34 may be an identification of the scarce resource 22 for which a preferred position 32 (or other priority access) may be provided. In one example, the existing queue for a scarce resource 34 may display to a user 26 a list of one or more nightclubs for which a user 26 may buy a preferred position for access. Similarly, the existing queue for scarce resource 34 may provide a list of one or more other events, venues, products, or services for which a preferred position 32 may be offered. In various embodiments, the existing queue for scare resource 34 may be a list, a search tool, or any other identification of one or more scarce resources 22 for which access may be offered. Similarly, in some embodiments of the system 10, the existing queue for scarce resource 34 may be a push notification provided to a user 26 through the user interface 28 on the user device 12. In a general sense, the existing queue for scarce resource 34 may be any identification of the scarce resource 22 for which priority access may be provided.

The preferred position 32 shown in FIG. 2 is an identification of the preferred position 32 for which the user 26 may gain access. For example, the preferred position 32 may indicate that a user 26 can skip the existing queue, advance to a preferred position along the queue, or select from amongst several available preferred positions 32. As will be understood by those skilled in the art based on the disclosures provided herein, the preferred position 32 may be any preferred access position for which a user 26 may be willing to pay for access and may be provided in any form, whether a single item, a list, a search tool, etc.

The variable price 30 shown in FIG. 2 is a display of the cost for purchasing the preferred position 32. The variable price 30 is a real-time, market-based price that may be based on any market-based factors. Such market-related factors may include supply and demand factors such as inventory, capacity, frequency of purchase, day, time of day, holidays, weather, etc. The market-related factors may further or alternatively include demographic related information and/or the past behavior of a specific user or type of user. As shown, these factors may or may not be independent of a given user 26. For example, the price may be lower for a user 26 (identified either specifically or by demographic factors) for whom the vendor 20 wants to provide a preferred position 32.

The purchase trigger 36 shown in FIG. 2 is a function provided through the user interface 28 through which the user 26 may purchase the preferred position 32 for the variable price 30. The purchase trigger 36 may be a simple command for executing the transaction based on information already stored in or accessible through the user interface 28 or may be a more complex order mechanism through which the user 26 enters all of the information required to execute the transaction. The purchase trigger 36 may take on various forms, each of which will be apparent to those skilled in the art based on the disclosure provided herein.

As further shown in FIG. 2, in response to purchase of preferred position 32, the user interface 28 may provide an access code 38 which the user 26 may use to gain access to the preferred position 32 relative to the scarce resource 22. The access code 38 may take many forms and may be appropriate to be visually shown to a gatekeeper, may be entered into an online form, or may otherwise be adapted for redemption of the purchase of a preferred position 32.

The user interface 28 shown in FIG. 2 is simply one example of a user interface 28 that may be employed in the system 10. Many variations in the execution of the user interface 28 will be apparent to those skilled in the art based on the descriptions provided herein.

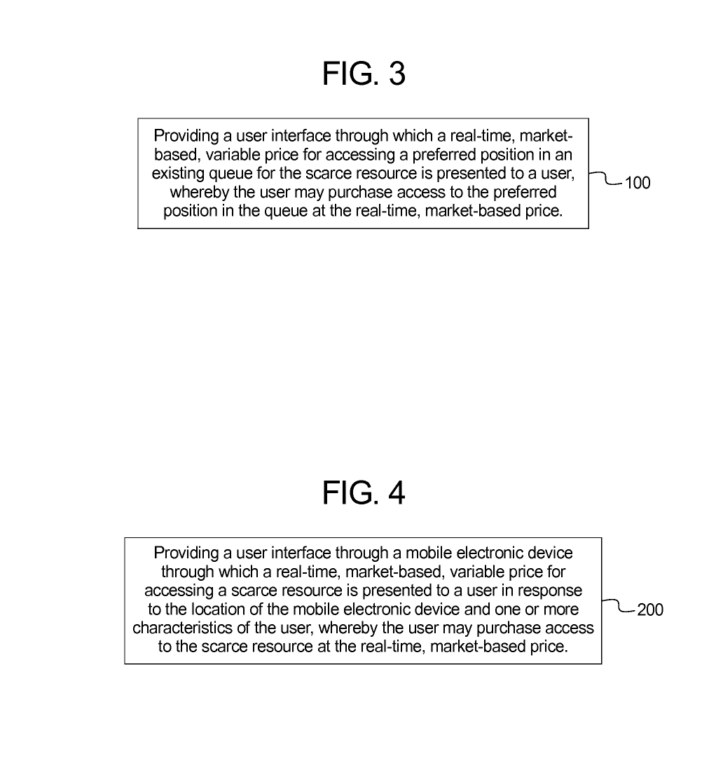

FIG. 3 illustrates a method 100 for providing real-time, market-based access to a scarce resource 22 comprising: providing a user interface 28 through which a real-time, market-based, variable price 30 for accessing a preferred position 32 in an existing queue 34 for the scarce resource 22 is presented to a user 26, whereby the user 26 may purchase access to the preferred position 32 in the queue 34 at the real-time, market-based variable price 30. The method 100 shown in FIG. 3 may be employed using the systems shown in FIGS. 1 and 2.

In some examples, the user 26 may take a single action to purchase access to the preferred position 32 in the queue 34 at the real-time, market-based variable price 30. As described above with respect to FIG. 1, the user interface 28 may be provided through a mobile electronic device 12.

In some examples, the preferred position 32 enables the user 26 to immediately bypass the queue 34. In other examples, the preferred position 32 is a better position along the queue 34 than the user 26 would be positioned without the purchase. The scarce resource 22 may be any of an event, a venue, a service, a product, etc.

FIG. 4 illustrates a method 200 comprising providing a user interface 28 through a mobile electronic device 12 through which a real-time, market-based, variable price 30 for accessing a scarce resource 22 is presented to a user 26 in response to the location of the mobile electronic device 12 and one or more characteristics of the user 26, whereby the user 26 may purchase access to the scarce resource 22 at the real-time, market-based price. The one or more characteristics of the user 26 may include one or more demographic characteristics, one or more purchase history characteristics, one or more characteristics derived from the user's interaction with the user interface 28, and/or one or more characteristics derived from one or more sources other than the user's interaction with the user interface 28.

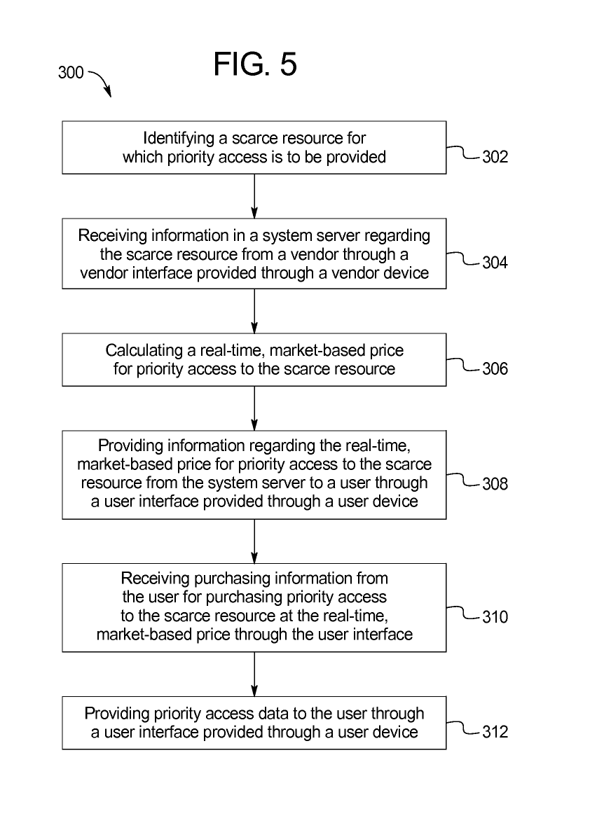

FIG. 5 illustrates a method 300 of providing real-time, market-based access to a scarce resource 22 comprising: a first step 302 of identifying a scarce resource 22 for which priority access is to be provided; a second step 304 of receiving information in a system server 16 regarding the scarce resource 22 from a vendor 20 through a vendor interface 24 provided through a vendor device 14; a third step 306 of calculating a real-time, market-based price for priority access to the scarce resource 22; a fourth step 308 of providing information regarding the real-time, market-based price for priority access to the scarce resource 22 from the system server 16 to a user 26 through a user interface 28 provided through a user device 12; a fifth step 310 of receiving purchasing information from the user 26 for purchasing priority access to the scarce resource 22 at the real-time, market-based price through the user interface 28; a sixth step 312 of providing priority access data to the user 26 through a user interface 28 provided through a user device 12.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A method comprising providing a user interface through which a real-time, market-based, variable price for accessing a preferred position in an existing queue for a scarce resource is presented to a user in response to the location of the mobile electronic device and one or more characteristics of the user, whereby the user may purchase access to the preferred position in the queue at the real-time, market-based variable price.

2. The method of claim 1 wherein the user may take a single action to purchase access to the preferred position in the queue at the real-time, market-based price.

3. The method of claim 1 wherein the user interface is provided through a mobile electronic device.

4. The method of claim 1 wherein the preferred position enables the user to immediately bypass the queue.

5. The method of claim 1 wherein the preferred position is a better position along the queue than the user would be positioned without the purchase.

6. The method of claim 1 wherein the scarce resource is access to one of an event, a venue, a service, or a product.

7. The method of claim 1 further including the step of receiving an access code through the user interface with which a user may claim the access to the preferred position.

8. An apparatus for providing real-time, market-based access to a scarce resource, the apparatus comprising:
a mobile electronic device; and
a user interface enabling a user to purchase access to a preferred position in an existing queue for a scarce resource at a real-time, market-based, variable price through the mobile electronic device.

9. The apparatus of claim 8 wherein the user interface further enables a user to take a single action through the mobile electronic device to purchase access to the preferred position in the existing queue for the scarce resource at the real-time, market-based price.

10. The apparatus of claim 8 wherein the preferred position enables the user to immediately bypass the queue.

11. The apparatus of claim 8 wherein the preferred position is a better position along the queue than the user would be positioned without the purchase.

12. The apparatus of claim 8 wherein the scarce resource is access to one of an event, a venue, a service, or a product.

13. The apparatus of claim 8 further including the step of receiving an access code through the mobile device with which a user may claim the access to the preferred position.

14. A method comprising providing a user interface through a mobile electronic device through which a real-time, market-based, variable price for accessing a scarce resource is presented to a user in response to the location of the mobile electronic device and one or more characteristics of the user, whereby the user may purchase access to the scarce resource at the real-time, market-based variable price.

15. The method of claim 14 wherein the one or more characteristics of the user include at least one demographic characteristic.

16. The method of claim 14 wherein the one or more characteristics of the user include at least one purchase history characteristic.

17. The method of claim 14 wherein the one or more characteristics of the user are derived from the user's interaction with the user interface.

18. The method of claim 14 wherein the one or more characteristics are derived from one or more sources other than the user's interaction with the user interface.
